(19) United States
(12) Patent Application Publication
(10) Pub. No.: US 2022/0070805 A1
(43) Pub. Date: Mar. 3, 2022

(54) COMMUNICATION APPARATUS AND COMMUNICATION METHOD

(71) Applicant: NTT DOCOMO, INC., Tokyo (JP)

(72) Inventor: Tomoya Ohara, Chiyoda-ku, Tokyo (JP)

(73) Assignee: NTT DOCOMO, INC., Tokyo (JP)

(21) Appl. No.: 17/420,891

(22) PCT Filed: Jan. 10, 2019
(86) PCT No.: PCT/JP2019/000525

§ 371 Date: Jul. 6, 2021

(51) Int. Cl. H04W 56/00; H04W 4/46; H04W 72/02; H04W 48/08; H04W 48/16

(52) U.S. Cl. CPC H04W 56/0015; H04W 4/46; H04W 48/16; H04W 48/08; H04W 72/02

(57) ABSTRACT

There is provided a communication apparatus including a receiving unit that receives a first synchronization signal from a synchronization source; a control unit that identifies, prior to receiving the first synchronization signal by the receiving unit, a value corresponding to a number of times of relaying the first synchronization signal, and that identifies a resource assignment corresponding to the identified value; and a transmitting unit that transmits a second synchronization signal by using a transmission resource assigned by the identified resource assignment.

### TECHNICAL FIELD

The present invention relates to a communication apparatus and a communication method for a radio communication system.

### BACKGROUND ART

For Long Term Evolution (LTE) and an LTE successor system (e.g., LTE-Advanced (LTE-A) and, New Radio (NR) (which is also referred to as 5G)), sidelink (which is also referred to as Device to Device (D2D)) technology has been studied in which communication apparatuses, such as User Equipment (UE), directly communicate with each other without going through a base station (Non-Patent Document 1).

In addition, implementation of Vehicle to Everything (V2X) has been studied and technical specification documents have been developed. Here, V2X is a part of Intelligent Transport Systems (ITS) and, as illustrated in FIG. 1, V2X is a generic term for Vehicle to Vehicle (V2V), which implies a communication mode executed between vehicles; Vehicle to Infrastructure (V2I), which implies a communication mode executed between a vehicle and a rode-side unit (RSU: Road-Side Unit); Vehicle to Nomadic device (V2N), which implies a communication mode executed between a vehicle and a driver's mobile communication apparatus; and a Vehicle to Pedestrian (V2P), which implies a communication mode executed between a vehicle and a pedestrian's mobile communication apparatus.

### RELATED ART DOCUMENT

### Non-Patent Document

Non-Patent Document 1: 3GPP TS 38.213 V15.3.0(2018 September)

Non-Patent Document 2: 3GPP TS 38.211 V15.3.0(2018 September)

### SUMMARY OF THE INVENTION

### Problem to be Solved by the Invention

For establishing synchronization of a communication apparatus using a sidelink synchronization signal, if the number of communication apparatuses for relaying the sidelink synchronization signal from the first source of the synchronization signal (for example, GNSS or gNB) increases, accuracy of the synchronization may decrease, due to a time shift per relaying of the sidelink synchronization signal and/or the elapsed time.

There is a need for preventing, when synchronization of a communication apparatus is to be established by using a sidelink synchronization signal, accuracy of the synchronization from decreasing.

### Means for Solving the Problem

According to an aspect of the present invention, there is provided a communication apparatus including a receiving unit that receives a first synchronization signal from a synchronization source; a control unit that identifies, prior to receiving the first synchronization signal by the receiving unit, a value corresponding to a number of times of relaying the first synchronization signal, and that identifies a resource assignment corresponding to the identified value; and a transmitting unit that transmits a second synchronization signal by using a transmission resource assigned by the identified resource assignment.

### Advantage of the Invention

According to an embodiment, when synchronization of a communication apparatus is to be established by using a sidelink synchronization signal, accuracy of the synchronization can be prevented from being lowered.

### BRIEF DESCRIPTION OF DRAWINGS

FIG. 1 is a diagram for illustrating V2X;

FIG. 2A is a diagram for illustrating a sidelink;

FIG. 2B is a diagram for illustrating a sidelink;

FIG. 3 is a diagram for illustrating a MAC PDU used for sidelink communication;

FIG. 4 is a diagram for illustrating a format of an SL-SCH subheader;

FIG. 5 is a diagram for illustrating an example of a channel structure used in a sidelink;

FIG. 6 is a diagram illustrating a configuration example of a radio communication system according to an embodiment;

FIG. 7 is a diagram for illustrating a resource selection operation of a communication apparatus;

FIG. 8 is a diagram illustrating an example of a synchronization method when communication apparatuses are located inside and outside coverage of a base station 1.

FIG. 9 is a diagram illustrating an example of a synchronization method when a communication apparatus 20 is located outside coverage of a base station.

FIG. 10 is a diagram illustrating an example of a correspondence between the number of hops and a resource assignment.

FIG. 11 is a diagram illustrating an example of a correspondence between the number of hops and a resource assignment.

FIG. 12 is a diagram illustrating an example of a definition of the number of hops.

FIG. 13 is a diagram illustrating an example of a functional configuration of a base station 10 according to an embodiment;

FIG. 14 is a diagram illustrating an example of a functional configuration of a communication apparatus 20 according to an embodiment; and

FIG. 15 is a diagram illustrating an example of a hardware configuration of the base station 10 and a communication apparatus 20 according to an embodiment.

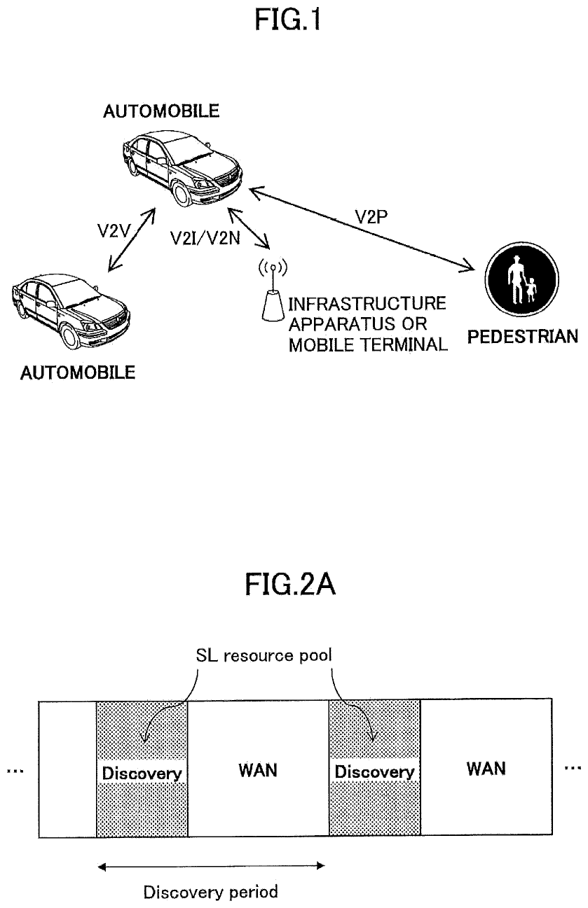

### EMBODIMENTS OF THE INVENTION

In the following, embodiments of the present invention (the embodiments) are described with reference to the drawings. The embodiments described below are merely examples, and the embodiments to which the present invention is applied are not limited to the following embodiments.

A method of direct communication between communication apparatuses according to the present embodiment is assumed to be LTE or NR sidelink (SL (Sidelink)), but the method of direct communication is not limited to this method. Additionally, the name “sidelink” is an example and UL (Uplink) may include a function of SL without using the name “sidelink.” SL may be distinguished from DL (Downlink) or UL by a difference in frequency or time resource and SL may have another name.

UL and SL may also be distinguished by a difference in one or more combinations of time resources, frequency resources, time and frequency resources, reference signals referenced to determine a pathloss in transmission power control, and reference signals used for synchronization (PSS/SSS/PSSS/SSSS).

For example, for UL, a reference signal of an antenna port X is used as a reference signal to be referenced to determine a Pathloss in transmission power control, and for SL (including UL used as SL), a reference signal of antenna port Y is used as a reference signal to be referenced to determine a Pathloss in transmission power control.

In the embodiments, it is mainly assumed that a communication apparatus is installed in a vehicle, but embodiments of the present invention are not limited to the embodiments. For example, a communication apparatus may be a communication apparatus carried by a person, a communication apparatus may be a device installed in a drone or an aircraft, or a communication apparatus may be a base station, an RSU, a relay station (relay node), user equipment having a scheduling capability, or the like.

### Outline of Sidelink

In the embodiments, a sidelink is used as a basic technique. Accordingly, as a basic example, an outline of a sidelink is described. Examples of the techniques described herein are those specified in 3GPP Rel. 14, or the like. The techniques may be used in NR, or a different technique may be used in NR.

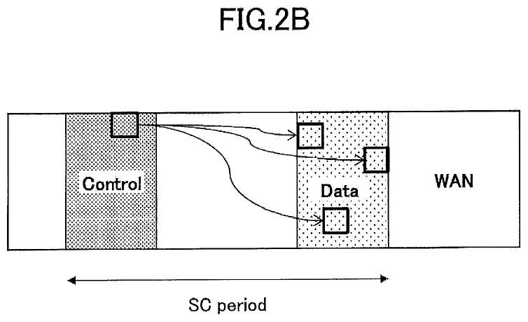

When the sidelink is broadly divided, the sidelink includes “discovery” and “communication.” For “discovery,” as illustrated in FIG. 2A, a resource pool for a Discovery message is configured for each Discovery period, and a communication apparatus (called UE) transmits a Discovery message (discovery signal) within that resource pool. More specifically, Type 1 and Type 2b are available. In Type 1, a communication apparatus autonomously selects a transmitting resource from the resource pool. In Type 2b, quasi-static resources are assigned by higher-layer signaling (e.g., RRC signals).

As illustrated in FIG. 2B, for “communication,” a resource pool for SCI (Sidelink Control Information)/data transmission is periodically configured. A transmitting communication apparatus signals a data transmission resource (PSCCH resource pool) or the like to a receiving side by SCI with a resource selected from a Control resource pool (PSSCH resource pool) and transmits the data using the data transmission resource. For Communication, more specifically, there are modes 1 and 2. In mode 1, resources are dynamically assigned by (Enhanced) Physical Downlink Control Channel ((E)PDCCH) transmitted from a base station to a communication apparatus. In mode 2, a communication apparatus autonomously selects a transmission resource from the resource pool. As the resource pool, a predefine pool is used, such as that signaled by SIB.

Furthermore, Rel-14 includes, in addition to mode 1 and mode 2, mode 3 and mode 4. In Rel-14, SCI and data can be simultaneously (in one subframe) transmitted in adjacent resource blocks in a frequency direction. Here, the SCI may be referred to as SA (scheduling assignment).

A channel used for “discovery” is referred to as Physical Sidelink Discovery Channel (PSDCH), a channel used for transmitting control information, such as SCI in “communication,” is referred to as Physical Sidelink Control Channel (PSCCH), and a channel for transmitting data may be referred to as Physical Sidelink Shared Channel (PSSCH). PSCCH and PSSCH have a structure based on PUSCH, and DMRS (Demodulation Reference Signal) is inserted in the structure.

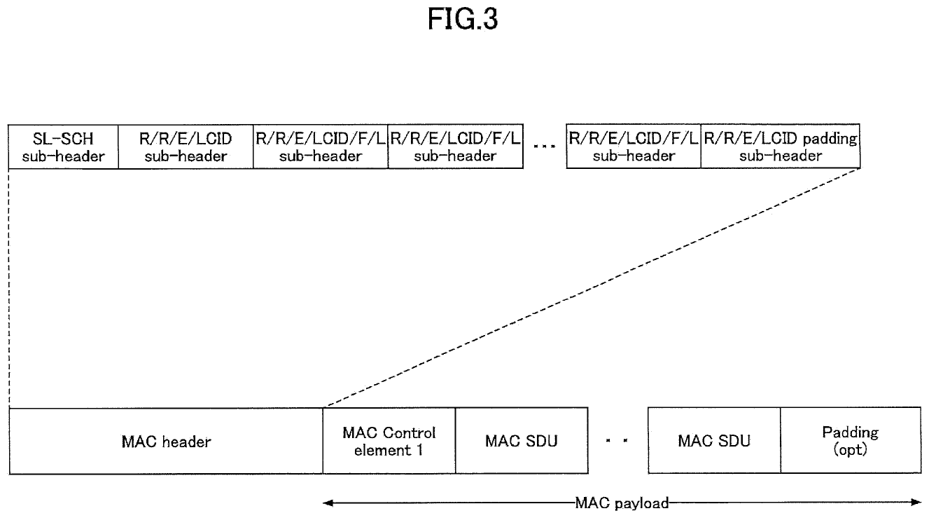

A Medium Access Control (MAC) Protocol Data Unit (PDU) used for sidelink includes at least a MAC header, MAC Control element, MAC SDU (Service Data Unit), and padding, as illustrated in FIG. 3. The MAC PDU may include any other information. A MAC header includes one Sidelink Shared Channel (SL-SCH) subheader and one or more MAC PDU subheaders.

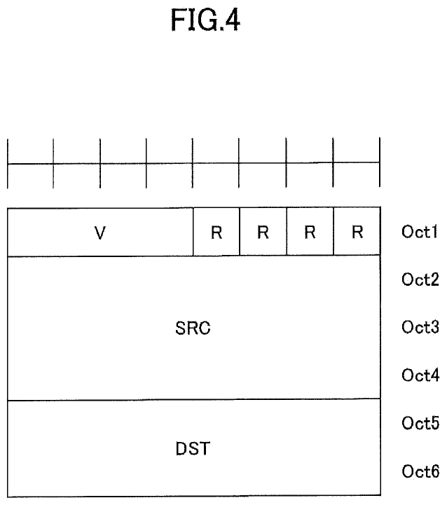

As illustrated in FIG. 4, a SL-SCH subheader includes a MAC PDU format version (V), source information (SRC), destination information (DST), Reserved bit (R), and the like. V is allocated at a start of the SL-SCH subheader and V indicates a MAC PDU format version used by a communication apparatus. In the source information, information on a transmission source is configured. In the transmission source information, an identifier of a ProSe UE ID is configured. In the destination information, information on a transmission destination is configured. Transmission destination information may be configured with information on a ProSe Layer-2 Group ID of the transmission destination.

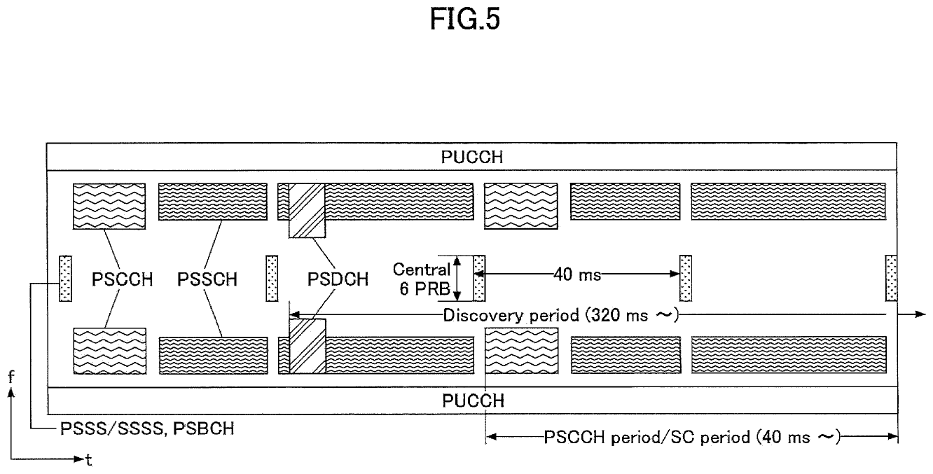

An example of a sidelink channel structure is illustrated in FIG. 5. As illustrated in FIG. 5, a PSCCH resource pool and a PSSCH resource pool used for “communication” are assigned. The PSDCH resource pool used for “discovery” is assigned with a period longer than a channel period of “communication.”

Furthermore, PSSS (Primary Sidelink Synchronization signal) and SSSS (Secondary Sidelink Synchronization signal) are used as synchronization signals for sidelink. For example, for an out-of-coverage operation, PSBCH (Physical Sidelink Broadcast Channel) is used, which is for transmitting broadcast information, such as a sidelink system bandwidth, a frame number, resource configuration information. PSSS/SSSS and PSBCH are transmitted, for example, in a single subframe. PSSS/SSSS may be referred to as SLSS.

The V2X assumed in the embodiments is a scheme related to “communication.” However, in the embodiments, there may be no distinction between “communication” and “discovery.” Furthermore, the techniques according to the embodiments may be applied to “discovery.”

### System Configuration

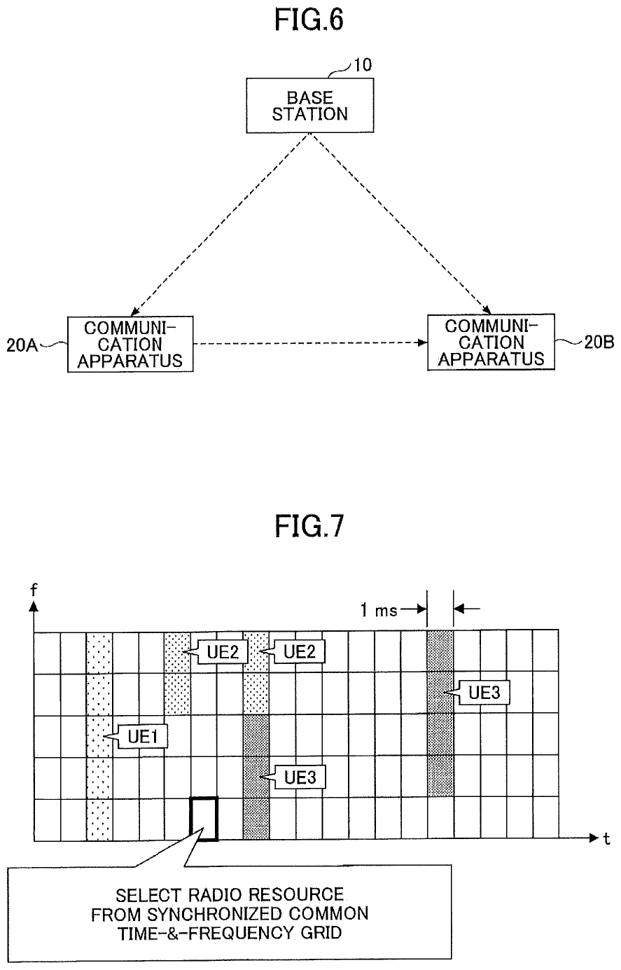

FIG. 6 is a diagram illustrating an example of a configuration of a radio communication system according to the embodiments. As illustrated in FIG. 6, a radio communication system according to the embodiments includes a base station 10, a communication apparatus 20A, and a communication apparatus 20B. Note that, in practice, there may be a large number of communication apparatuses, but FIG. 6 illustrates the communication apparatus 20A and the communication apparatus 20B as an example.

In FIG. 6, the communication apparatus 20A is intended to be the transmitting side and the communication apparatus 20B is intended to be the receiving side. However, each of the communication apparatus 20A and the communication apparatus 20B is provided with both transmission function and reception function. In the following, when the communication apparatuses 20A, 20B, and the like, are not particularly distinguished, they are simply described as the communication apparatus 20 or the communication apparatus. In FIG. 6, for example, a case is indicated in which both the communication apparatus 20A and the communication apparatus 20B are within the coverage. However, the operation according to the embodiments can be applied to a case in which all the communication apparatuses 20 are within the coverage; a case in which some of the communication apparatuses 20 are within the coverage and other communication apparatuses 20 are outside the coverage; and a case in which all the communication apparatuses 20 are outside the coverage.

In the embodiments, the communication apparatus 20 is, for example, a device installed in a vehicle such as an automobile and has a function of cellular communication as user equipment (UE) in the LTE or NR and a sidelink function. Additionally, the communication apparatus 20 includes functions, such as those of a GPS device, a camera, and various types of sensors, for obtaining report information (location, event information, and so forth). The communication apparatus 20 may be a typical mobile communication apparatus (such as a smartphone). The communication apparatus 20 may be an RSU. The RSU may be a UE-type RSU with UE functions, a BS-type RSU with base station functions (also referred to as gNB-type UE), or a relay station.

The communication apparatus 20 need not be a single-housing device. For example, even if various types of sensors are distributed in a vehicle, the device including the various types of sensors is the communication apparatus 20. The communication apparatus 20 need not include various types of sensors, and the communication apparatus 20 may include a function for transmitting data to and receiving data from the various types of sensors.

The details of processing of sidelink transmission by the communication apparatus 20 are basically the same as the details of processing of UL transmission in the LTE or NR. For example, the communication apparatus 20 scrambles a code word of transmission data, modulates to generate complex-valued symbols, and maps the complex-valued symbols to one or two layers for precoding. The precoded complex-valued symbols are then mapped to a resource element to generate a transmission signal (e.g., CP-OFDM, DFT-s-OFDM) and the transmission signal is transmitted from each antenna port.

The base station 10 has a function of cellular communication as the base station 10 in LTE or NR, and the base station 10 has a function for enabling communication of the communication apparatus 20 according to the embodiments (e.g., resource pool configuration, resource allocation, and the like). The base station 10 may be an RSU (gNB-type RSU), a relay station, or a communication apparatus having a scheduling function.

In the radio communication system according to the embodiments, a signal waveform used by the communication apparatus 20 for SL or UL may be OFDMA, SC-FDMA, or other signal waveforms. In the radio communication system according to the embodiments, as an example, a frame including a plurality of subframes (e.g., 10 subframes) is formed in the time direction, and the frequency direction is formed of a plurality of subcarriers. One subframe is an example of one transmission Time Interval (TTI). However, TTIs are not necessarily subframes. For example, a TTI may be in units of slots or mini-slots or other time domain units. In addition, the number of slots per subframe may be determined in accordance with subcarrier spacing. The number of symbols per slot may be 14.

In the embodiments, the communication apparatus 20 may take any of the following modes: a mode 1 in which resources are dynamically assigned by (Enhanced) Physical Downlink Control Channel ((E) PDCCH) transmitted from the base station 10 to the communication apparatus; a mode 2 in which the communication apparatus autonomously selects transmission resources from the resource pool; a mode (which is referred to as mode 3, hereinafter) in which resources for SL signal transmission are assigned by the base station 10; and a mode (which is referred to as mode 4, hereinafter) in which resources for SL signal transmission are autonomously selected. For example, a mode is configured for the communication apparatus 20 by the base station 10.

As illustrated in FIG. 7, the communication apparatus of mode 4 (indicated as UE in FIG. 7) selects radio resources from a synchronized common time and frequency grid. For example, the communication apparatus 20 senses in the background to identify, as candidate resources, resources with good sensing results that are not reserved by another communication apparatus and selects, from the candidate resources, a resource to be used for transmission.

For communication, synchronization refers to correctly aligning timing between a transmitting side and a receiving side, so as to correctly transmit and receive data. As a method of establishing synchronization, a method can be considered in which a signal for aligning timing between a transmitting side and a receiving side, namely, a synchronization signal, is transmitted.

In LTE-based V2X, a sidelink synchronization signal (SLSS: Synchronization signal via sidelink) and a physical sidelink broadcast channel (PSBCH: PBCH via sidelink, broadcast information) are transmitted by a user equipment, and another user equipment can use those signals to establish synchronization.

For example, since another user equipment located outside coverage of a base station may be unable to use a synchronization signal transmitted from the base station as a direct synchronization source, the other user equipment may use a synchronization signal transmitted from the user equipment as a synchronization source, as described above.

It has been agreed that at least a sidelink synchronization signal, PSBCH, and a sidelink synchronization source are to be used for sidelink synchronization for NR V2X. As a sidelink synchronization source, for example, the following may be used: a global navigation satellite system (GNSS); a gNodeB (gNB), which is a base station for 5G; a user equipment (UE) for 5G; and user equipment (UE) for LTE.

Here, a signal corresponding to a sidelink synchronization signal (SLSS) and PSBCH may be referred to as an SLSS block, an SLSS/PBCH block, an SLSS/PSBCH block, and the like. In this specification, a signal corresponding to SLSS and PSBCH is referred to as SL-SSB. SL-SSB may include Demodulation Reference Signal (DM-RS) and the like.

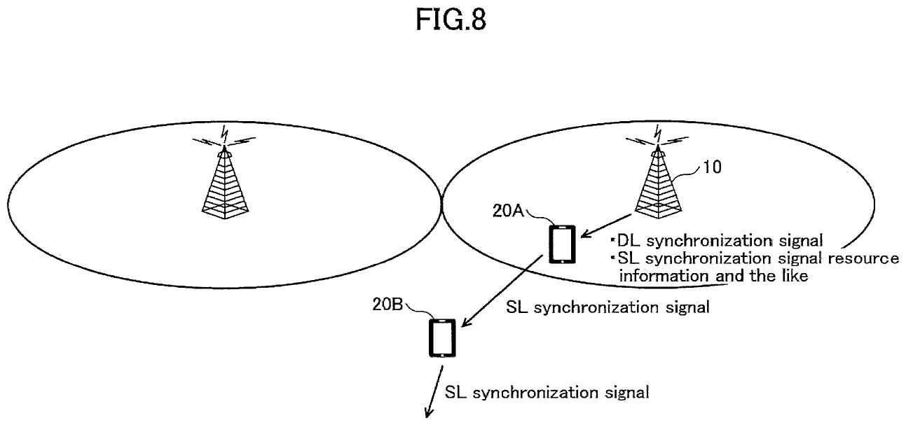

FIG. 8 is a diagram illustrating an example of a synchronization method in a case where the communication apparatus 20A is located inside coverage of the base station 10 and the communication apparatus 20B is located outside the coverage of the base station 10. First, the communication apparatus 20A located inside the coverage of the base station 10 receives, from the base station 10, a downlink synchronization signal and information on a radio resource for transmitting a sidelink synchronization signal. By receiving the downlink synchronization signal from the base station 10, the communication apparatus 20A establishes synchronization for communicating with the base station 10. In response to receiving from the base station 10 the information on the radio resource for the sidelink communication for transmitting the sidelink synchronization signal, the communication apparatus 20A transmits, by using the radio resource for the sidelink communication, a sidelink synchronization signal using the base station 10 as a synchronization source. When the communication apparatus 20B located outside the coverage of the base station 10 receives the sidelink synchronization signal from the communication apparatus 20A, the communication apparatus 20B establishes synchronization for communicating with the communication apparatus 20A through the sidelink. The communication apparatus 20B transmits a sidelink synchronization signal using the communication apparatus 20A as a synchronization source.

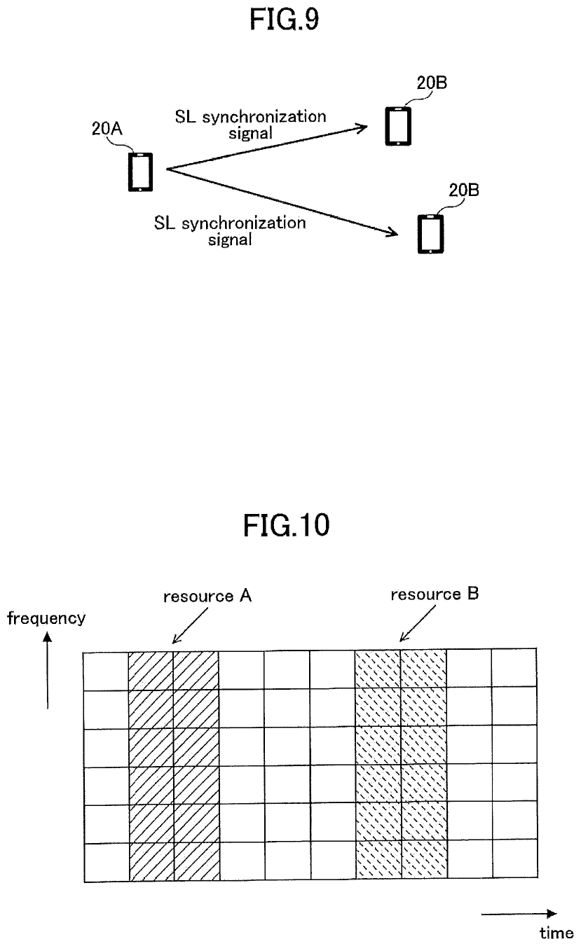

FIG. 9 is a diagram illustrating an example of a synchronization method in a case where both of the communication apparatus 20A and the communication apparatus 20B are located outside the coverage of the base station 10. For example, the communication apparatus 20A uses a synchronization signal from GNSS to establish synchronization using the GNSS as a synchronization source. The communication apparatus 20A transmits, to the communication apparatus 20B, a sidelink synchronization signal using the GNSS as a synchronization source. By receiving the sidelink synchronization signal transmitted from the communication apparatus 20A, the communication apparatus 20B establishes synchronization for communicating with the communication apparatus 20A through the sidelink. In this case, the communication apparatus 20B may transmit a sidelink synchronization signal using the communication apparatus 20A as a synchronization source. Since the communication apparatus 20A is located outside the coverage of the base station 10, the communication apparatus 20A is unable to receive broadcast information or the like from the base station 10. Accordingly, the communication apparatus 20A may transmit a sidelink synchronization signal by using resource information and the like for a sidelink synchronization signal that is preconfigured in the communication apparatus 20A itself or in a Subscriber Identity Module (SIM).

### Problem

If the number of communication apparatuses 20 for relaying a sidelink synchronization signal from the first source of synchronization (for example, GNSS or gNB) increases, accuracy of the synchronization may decrease due to a time shift per relaying of the sidelink synchronization signal and/or the elapsed time. Here, the number of the communication apparatuses 20 for relaying a synchronization signal, namely, the number of times of relaying the synchronization signal, may be referred to as the number of hops, for example. However, the definition of the number of hops is not limited to this example.

Here, when the communication apparatus 20 is to relay a synchronization signal, the communication apparatus 20 is to perform a reception and a transmission. In this case, there is a slight timing shift between the synchronization signal received by the communication apparatus 20 and the sidelink synchronization signal transmitted by the communication apparatus 20 according to the characteristics of the receiver and the transmitter. Accordingly, when the number of hops increases, such timing shifts may accumulate, and the timing shift may increase.

In addition, as time elapses, a distance of a path for relaying a synchronization signal by the communication apparatus 20 to another communication apparatus may change. In general, when the communication apparatus 20A transmits a sidelink synchronization signal, and when the communication apparatus 20B aligns timing with the communication apparatus 20A for sidelink communication with the communication apparatus 20A by receiving the sidelink synchronization signal transmitted from the communication apparatus 20A, the timing varies depending on the distance between the communication apparatus 20A and the communication apparatus 20B. Namely, a timing for receiving a signal transmitted from the communication apparatus 20A by the communication apparatus 20B varies depending on a propagation time for a radio wave transmitted from the communication apparatus 20A to arrive at the communication apparatus 20B. Accordingly, especially in a case where the number of hops is large, the accuracy of the synchronization may decrease when the communication apparatus 20 relaying a sidelink synchronization signal moves.

As a solution to solve the problem of a decrease in synchronization accuracy due to an increase in the number of hops described above, for example, when the communication apparatus 20A relays a synchronization signal to the communication apparatus 20B, the communication apparatus 20A may transmit the number of hops to the communication apparatus 20B.

For example, when the communication apparatus 20A receives a synchronization signal transmitted from the base station 10 and relays to the communication apparatus 20B the sidelink synchronization signal using the base station 10 as a synchronization source, the communication apparatus 20A may transmit a notification to the communication apparatus 20B that the number of hops is one. When the communication apparatus 20A receives a sidelink synchronization signal transmitted from another communication apparatus 20 and relays to the communication apparatus 20B the sidelink synchronization signal using the another communication apparatus 20 as a synchronization source, the communication apparatus 20A may transmit, to the communication apparatus 20B, a notification of a value obtained by adding one to the hop number transmitted from the another communication apparatus 20. As described above, the communication apparatus 20 having received a sidelink synchronization signal from another communication apparatus 20 may determine, according to the number of hops notified from the another communication apparatus 20, whether a sidelink synchronization signal is transmitted (relayed) or not. In other words, the communication apparatus 20 can determine the synchronization accuracy of the sidelink synchronization signal on the basis of the number of hops provided as a notification along with the sidelink synchronization signal, and can select as to whether the received sidelink synchronization signal is to be used for synchronization processing of the communication apparatus 20 or another synchronization signal is to be used for synchronization processing of the communication apparatus 20.

In a case where a transmitting communication apparatus 20 transmits a notification of the number of hops of a synchronization signal to the receiving communication apparatus 20, for example, the transmitting communication apparatus 20 may include the number of hops in a payload of PSBCH transmitted by the transmitting communication apparatus 20. Alternatively, for example, a transmitting communication apparatus 20 may include the number of hops in DM RS transmitted by the transmitting communication apparatus 20. Here, DM RS may be included in PSBCH. Including the number of hops in DM RS means that a notification of the number of hops is transmitted by combining both the payload of PSBCH and a DM RS sequence.

In a case where the transmitting communication apparatus 20 notifies the number of hops of the synchronization signal to the receiving communication apparatus 20, for example, the transmitting communication apparatus 20 applies a sequence associated with the number of hops to a sidelink synchronization signal, and the receiving communication apparatus 20 may determine the number of hops of the synchronization signal on the basis of a sequence applied to the received sidelink synchronization signal. For example, the number of hops of the synchronization signal may be determined on the basis of the DM RS sequence, or the number of hops of the synchronization signal may be determined on the basis of the synchronization signal sequence. Here, DM RS may be included in PSBCH. The synchronization signal sequence may be a sequence of PSS or SSS. Additionally or alternatively, the transmitting communication apparatus 20 may apply an identifier (ID) corresponding to the number of hops to a sidelink synchronization signal, and the receiving communication apparatus 20 may determine the number of hops of the received synchronization signal, on the basis of an identifier applied to the received synchronization signal. The ID may be, for example, an SLSSID used for generating a synchronization signal.

When the transmitting communication apparatus 20 transmits a notification of the number of hops of the synchronization signal to the receiving communication apparatus 20, for example, the transmitting communication apparatus 20 may use the location of the transmission resource corresponding to the number of hops to transmit a sidelink synchronization signal, and the receiving communication apparatus 20 may determine the number of hops of the synchronization signal on the basis of the location of the reception resource on which the sidelink synchronization signal has been received. Additionally or alternatively, for example, the transmitting communication apparatus 20 may use the location of the transmission resource corresponding to the number of hops to transmit the signal of PSBCH, and the receiving communication apparatus 20 may determine the number of hops of the synchronization signal according to the location of the reception resource on which the signal of PSBCH has been received. A notification of the number of hops of the synchronization may be transmitted by combining the notification methods using a payload of PSBCH, a sequence, and an ID described above.

When the transmitting communication apparatus 20 notifies the number of hops of the synchronization signal to the receiving communication apparatus 20, a notification of the number of hops itself may be transmitted. Alternatively, a notification of a numerical value (or an index) associated with a range of the number of hops may be transmitted. For example, when the range of the number of hops is less than or equal to x (x is an integer greater than or equal to zero), a numerical value 0 may be provided. Alternatively, in a case where the number of hops is greater than or equal to x, a numerical value 1 may be provided. For example, in a case where the number of hops is 1, the transmitting communication apparatus 20 may set a predetermined bit indicating the number of hops to zero, and transmit the predetermined bit to the receiving communication apparatus 20. In a case where the number of hops is greater than or equal to 2, the transmitting communication apparatus 20 may set a predetermined bit indicating the number of hops to 1, and transmit the predetermined bit to the receiving communication apparatus 20.

In a case where the transmitting communication apparatus 20 notifies the number of hops of a synchronization signal to the receiving communication apparatus 20, for example, a correspondence between the number of hops and a resource assignment may be defined at a network side, and the network may transmit a notification of the information indicating the correspondence to the transmitting communication apparatus 20 and the receiving communication apparatus 20. In this case, for example, the transmitting communication apparatus 20 may transmit a notification of the number of hops of a synchronization signal to the receiving communication apparatus 20 by transmitting the sidelink synchronization signal by using a resource assigned by a resource assignment corresponding to the number of hops of the synchronization signal. Additionally or alternatively, the transmitting communication apparatus 20 may transmit a notification of the number of hops of the synchronization signal to the receiving communication apparatus 20 by transmitting a signal of PSBCH by using a resource assigned by a resource assignment associated with the number of hops of the synchronization signal. The receiving communication apparatus 20 may search for a synchronization signal from resources in the descending order of priority (for example, a resource corresponding to a fewer number of hops). In this case, for example, the number of searches up to detection of a synchronization signal and the number of hops of the synchronization signal may be associated with each other.

For example, the network may associate a range in which the number of hops is less than or equal to x (x is an integer greater than or equal to zero) and a resource A illustrated in FIG. 10 with each other, and may associate a range in which the number of hops is greater than or equal to x+1 and a resource B illustrated in FIG. 10. In this case, for example, where the number of hops of the synchronization signal is less than or equal to x, the transmitting communication apparatus 20 may transmit a sidelink synchronization signal on the resource A illustrated in FIG. 10. For example, in a case where the number of hops of the synchronization signal is greater than or equal to x+1, the transmitting communication apparatus 20 may transmit a sidelink synchronization signal on a resource B illustrated in FIG. 10. For example, in a case where the receiving communication apparatus 20 receives a sidelink synchronization signal on the resource A illustrated in FIG. 10, the receiving communication apparatus 20 can determine that the number of hops is less than or equal to x. For example, in a case where the receiving communication apparatus 20 receives a sidelink synchronization signal on the resource B illustrated in FIG. 10, the receiving communication apparatus 20 can determine that the number of hops is greater than or equal to x+1.

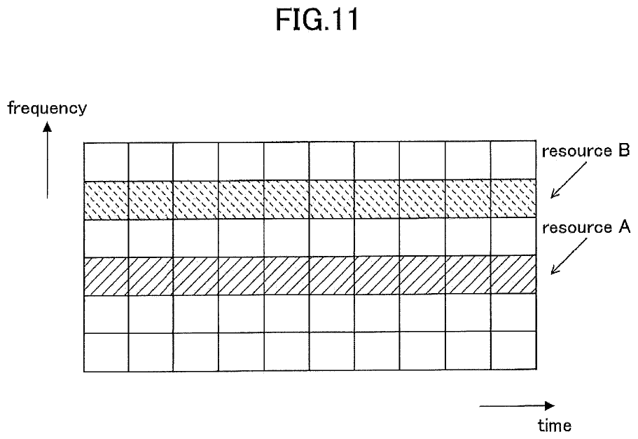

Alternatively, for example, the network may associate a range in which the number of hops is less than or equal to x (x is an integer greater than or equal to zero) and the resource A illustrated in FIG. 11, and may associate a range in which the number of hops is greater than or equal to 2 and the resource B illustrated in FIG. 11. In this case, for example, where the number of hops of the synchronization signal is less than or equal to x, the transmitting communication apparatus 20 may transmit a sidelink synchronization signal through the resource A illustrated in FIG. 11. For example, in a case where the number of hops of the synchronization signal is greater than or equal to x+1, the transmitting communication apparatus 20 may transmit a sidelink synchronization signal through the resource B illustrated in FIG. 11. For example, in a case where the receiving communication apparatus 20 receives a sidelink synchronization signal through the resource A illustrated in FIG. 11, the receiving communication apparatus 20 can determine that the number of hops is less than or equal to x. For example, in a case where the receiving communication apparatus 20 receives a sidelink synchronization signal through the resource B illustrated in FIG. 11, the receiving communication apparatus 20 can determine that the number of hops is greater than or equal to x+1. In the above-described example, a range of the number of hops and a time and/or frequency resource are associated, but the association between the range of the number of hops and the resource is not limited to the above-described examples. For example, a range of the number of hops may be associated with a type of a spread code used for a sidelink communication.

In a case where the transmitting communication apparatus 20 transmits a notification of the number of hops of the synchronization signal to the receiving communication apparatus 20, for example, the receiving communication apparatus 20 may determine whether to transmit (relay) a sidelink synchronization signal according to the received number of hops of the synchronization signal. For example, a threshold value X may be predefined. When the number of hops of the synchronization signal received by the receiving communication apparatus 20 is greater than the threshold value X, the receiving communication apparatus 20 may determine not to transmit (relay) a sidelink synchronization signal.

In the above-described example, an example of a method has been described in which the transmitting communication apparatus 20 transmits a notification of the number of hops of the synchronization signal to the receiving communication apparatus 20. Hereinafter, an example of an operation of the receiving communication apparatus 20 detecting the number of hops of the synchronization signal is described.

The receiving communication apparatus 20 may select a type of a synchronization signal used for sidelink communication according to the detected number of hops of the synchronization signal.

For example, in a case where the receiving communication apparatus 20 receives multiple types of sidelink synchronization signals, the receiving communication apparatus 20 may detect a minimum number of hops from the multiple numbers of hops by comparing the multiple numbers of hops of the multiple types of sidelink synchronization signals, and may use the type of the sidelink synchronization signal associated with the detected minimum number of hops, for synchronization for sidelink communication by the receiving communication apparatus 20. Namely, the receiving communication apparatus 20 may preferentially select a sidelink synchronization signal with a low number of hops.

Additionally or alternatively, a threshold value X may be defined for the number of hops of the synchronization signal. In this case, for example, in a case where the number of hops of the received synchronization signal is less than or equal to the threshold value X, the receiving communication apparatus 20 may preferentially use the received sidelink synchronization signal. For example, in a case where the received number of hops of the synchronization signal is greater than the threshold value X, the receiving communication apparatus 20 may select another synchronization signal (for example, a synchronization signal using an eNB as a synchronization source), and may use the selected another synchronization signal for synchronization processing. In the above-described example, for example, in a case where a synchronization source of a sidelink synchronization signal is gNB, which is a 5G base station, synchronization can be performed which reflects granularity (Numerology or subcarrier spacing). This enables an operation such that, when the number of hops of the synchronization signal is less than or equal to a threshold value X, a synchronization source of a sidelink synchronization signal using gNB as a synchronization source is preferentially adopted, and in a case where the number of hops of the synchronization signal is greater than the threshold value X, a synchronization signal using, as a synchronization source, an eNB with high synchronization accuracy that does not take granularity into account is preferentially adopted.

Alternatively, in a case where a threshold value X is defined for the number of hops of the synchronization signal, and where, for example, the number of hops of the received synchronization signal is less than or equal to the threshold value X, the receiving communication apparatus 20 may preferentially use the received sidelink synchronization signal. For example, in a case where the number of hops of the received synchronization signal is greater than the threshold value X, the receiving communication apparatus 20 may determine not to use the received synchronization signal to perform the synchronization processing.

In the above-described example, the priority level may be different depending on the type of the first synchronization source. Additionally, in the above-described example, the priority level may be different according to, e.g., whether the communication apparatus 20 is located inside the coverage of the base station 10 or the communication apparatus 20 is located outside the coverage of the base station 10. For example, in a case where the initial synchronization source is gNB, the degree of priority of the sidelink synchronization signal for a case where the number of hops of the synchronization signal is 1 may be set to 5, and the degree of priority of the sidelink synchronization signal for a case where the number of hops of the synchronization signal is 2 may be set to 4. For example, in a case where the initial synchronization source is eNB, the degree of priority of the sidelink synchronization signal for a case where the number of hops of the synchronization signal is 1 may be set to 3, and the degree of priority of the sidelink synchronization signal for a case where the number of hops of the synchronization signal is 2 may be set to 2.

For example, in a case where the initial synchronization source is gNB, and the communication apparatus 20 is located inside the coverage of eNB, the degree of priority of the sidelink synchronization signal for a case where the number of hops of the synchronization signal is 1 may be set to 5, and the degree of priority of the sidelink synchronization signal for a case where the number of hops of the synchronization signal is 2 may be set to 2. For example, in a case where the initial synchronization source is gNB, and the communication apparatus 20 is located outside the coverage of eNB, the degree of priority of the sidelink synchronization signal for a case where the number of hops of the synchronization signal is 1 may be set to 5, and the degree of priority of the sidelink synchronization signal for a case where the number of hops of the synchronization signal is 2 may be set to 4.

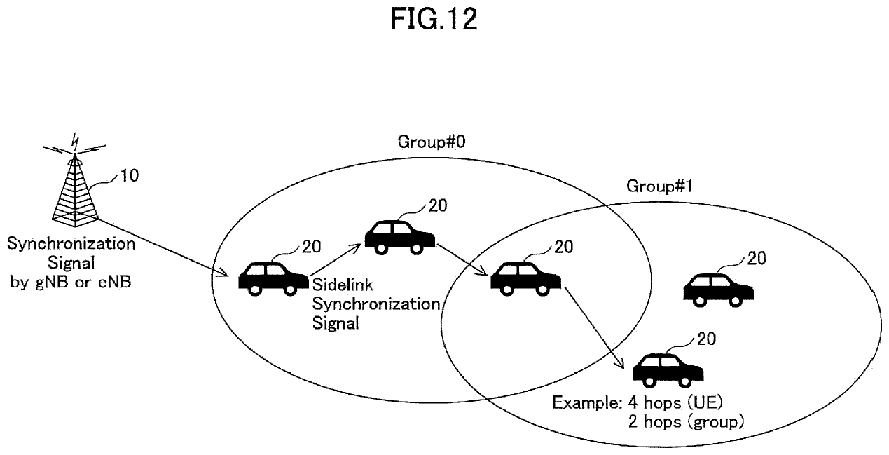

In the above-described example, the number of communication apparatuses 20 relaying a sidelink synchronization signal is used as the number of hops. However, the definition of the number of hops is not limited to this example. Here, FIG. 12 illustrates an example in which synchronization is established between a plurality of communication apparatuses 20 included in a group #0, and synchronization is established between a plurality of communication apparatuses 20 included in a group #1. In this case, for example, the number of hops may be defined as the number of groups that relay the sidelink synchronization signal. For example, when the synchronization signal using the base station 10 as a synchronization source is relayed from the group #0 to the group #1, the number of hops of the synchronization signal may be set to 2. In the example illustrated in FIG. 12, alternately, the number of hops of the synchronization signal may be set to 4, because the sidelink synchronization signal is relayed by four communication apparatus 20.

### Device Configuration

Next, a functional configuration example of the base station 10 and the communication apparatus 20 that perform the processing operations described above is described.

### Base Station 10

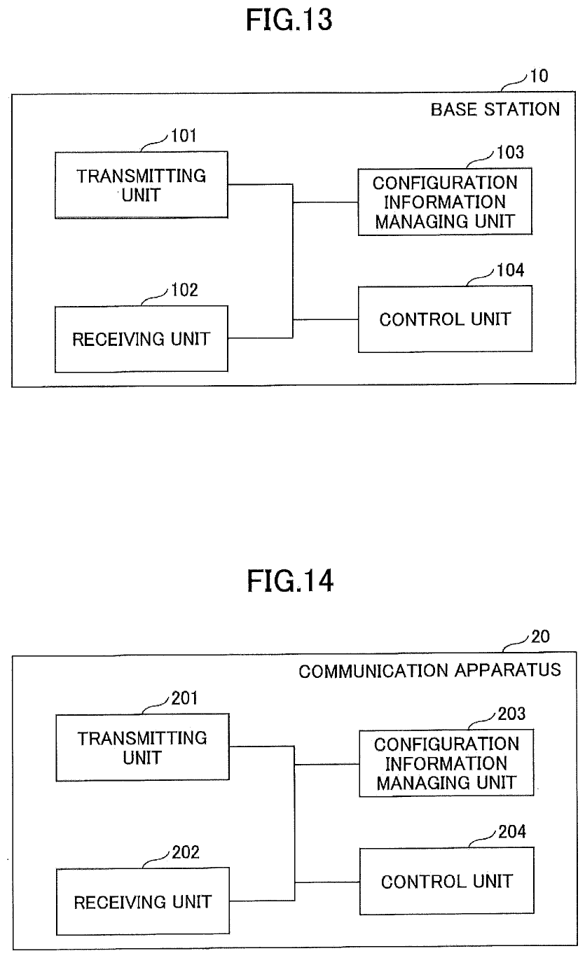

FIG. 13 is a diagram illustrating an example of a functional configuration of the base station 10. As illustrated in FIG. 13, the base station 10 includes a transmitting unit 101, a receiving unit 102, a configuration information managing unit 103, and a control unit 104. The functional configuration illustrated in FIG. 13 is merely one example. The functional division and names of functional units may be any division and names, provided that the operation according to the embodiments of the present invention can be performed. Note that the transmitting unit 101 may be referred to as a transmitter, and the receiving unit 102 may be referred to as a receiver.

The transmitting unit 101 includes a function for generating a signal to be transmitted to the communication apparatus 20 side and transmitting the signal through radio. The receiving unit 102 includes a function for receiving various types of signals transmitted from the communication apparatus 20 through radio and obtaining a higher layer signal from the received signal. Furthermore, the receiving unit 102 includes a function for measuring a received signal to obtain a quality value.

The configuration information managing unit 103 stores preconfigured configuration information, configuration information received from the communication apparatus 20, and the like. Note that configuration information related to transmission may be stored in the transmitting unit 101, and configuration information related to reception may be stored in the receiving unit 102. The control unit 104 controls the base station 10. Note that a function of the control unit 104 related to transmission may be included in the transmitting unit 101, and a function of the control unit 104 related to reception may be included in the receiving unit 102.

For example, the control unit 104 may define a correspondence between the number of hops and a resource assignment, and the control unit 104 may store the defined correspondence in the configuration information managing unit 103. Furthermore, the transmitting unit 101 may transmit the defined correspondence to the communication apparatus 20.

### Communication Apparatus 20

FIG. 14 is a diagram illustrating an example of a functional configuration of the communication apparatus 20. As illustrated in FIG. 14, the communication apparatus 20 includes a transmitting unit 201, a receiving unit 202, a configuration information managing unit 203, and a control unit 204. The functional configuration illustrated in FIG. 14 is merely an example. The functional division and names of functional units may be any division and names, provided that the operation according to the embodiments can be performed. Note that the transmitting unit 201 may be referred to as a transmitter, and the receiving unit 202 may be referred to as a receiver. Furthermore, the communication apparatus 20 may be the transmitting communication apparatus 20A or the receiving communication apparatus 20B.

The transmitting unit 201 generates a transmitting signal from transmitting data and transmits the transmitting signal through radio. The receiving unit 202 receives various types of signals and obtains a higher layer signal from the received physical layer signal. The receiving unit 202 includes a function for measuring a received signal and obtaining a quality value. The configuration information managing unit 203 stores preconfigured configuration information, configuration information received from the base station 10, and the like. The configuration information managing unit 203 may store a correspondence between the number of hops and a resource assignment received from the base station 10 or another communication apparatus 20 through the receiving unit 202. Note that configuration information related to transmission may be stored in the transmitting unit 201 and configuration information related to reception may be stored in the receiving unit 202. The control unit 204 controls the communication apparatus 20. Note that the function of the control unit 204 related to transmission may be included in the transmitting unit 201, and the function of the control unit 204 related to reception may be included in the receiving unit 202.

For example, the control unit 204 may determine the number of hops of a synchronization signal based on a synchronization signal and/or PSBCH received by the receiving unit 202 from the base station 10 or another communication apparatus 20. Furthermore, the control unit 204 may select, based on the number of hops of a synchronization signal, whether the synchronization signal received by the receiving unit 202 is used for synchronization processing. Furthermore, when the control unit 204 establishes synchronization by using a synchronization signal received by the receiving unit 202, and when the control unit 204 causes the transmitting unit 201 to transmit a sidelink synchronization signal, the number of hops of the sidelink synchronization signal to be transmitted by the transmitting unit 201 may be transmitted to another communication apparatus 20 by a method, such as a method of including the number of hops in a payload of PSBCH to be transmitted; a method of including the number of hops in DMRS to be transmitted; a method of applying a sequence corresponding to the number of hops to the sidelink synchronization signal; or a method of transmitting the sidelink synchronization signal by using a location of a transmission resource corresponding to the number of hops.

### Hardware Configuration

The block diagrams (FIG. 13 to FIG. 14) used for the description of the above embodiments show blocks of functional units. These functional blocks (components) are implemented by any combination of at least one of hardware and software. In addition, the implementation method of each functional block is not particularly limited. That is, each functional block may be implemented using a single device that is physically or logically combined, or may be implemented by directly or indirectly connecting two or more devices that are physically or logically separated (e.g., using wire, radio, etc.) and using these multiple devices. The functional block may be implemented by combining software with the above-described one device or the above-described plurality of devices. Functions include, but are not limited to, judgment, decision, determination, computation, calculation, processing, derivation, research, search, verification, reception, transmission, output, access, resolution, choice, selection, establishment, comparison, assumption, expectation, deeming, broadcasting, notifying, communicating, forwarding, configuring, reconfiguring, allocating, mapping, assigning, etc. For example, a functional block (component) that functions to transmit is called a transmitting unit or a transmitter. In either case, as described above, the implementation method is not particularly limited.

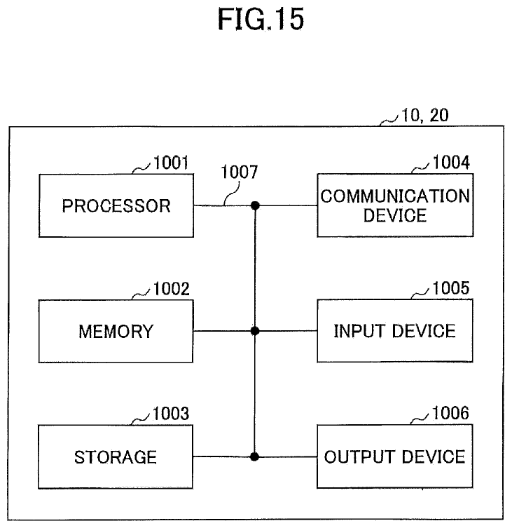

For example, the communication apparatus 20 and the base station 10 according to the embodiments of the present invention may function as computers performing the process of the radio communication according to the embodiments of the present invention. FIG. 15 is a diagram illustrating an example of a hardware configuration of the communication apparatus 20 and the base station 10 according to the embodiments. Each of the above-described communication apparatus 20 and base station 10 may be physically configured as a computer device including a processor 1001, a memory 1002, a storage 1003, a communication device 1004, an input device 1005, an output device 1006, a bus 1007, and the like.

Note that, in the following description, the term “device” can be replaced with a circuit, a device, a unit, and so forth. The hardware configuration of the communication apparatus 20 and the base station 10 may be configured to include one or more of the devices depicted in the figures, which are indicated by 1001 through 1006, or may be configured without some devices.

Each function of the communication apparatus 20 and the base station 10 is implemented by loading predetermined software (program) on hardware, such as the processor 1001 and the memory 1002, so that the processor 1001 performs computation and controls communication by the communication device 1004, and at least one of reading and writing of data in the memory 1002 and the storage 1003.

The processor 1001, for example, operates an operating system to control the entire computer. The processor 1001 may be configured with a central processing unit (CPU: Central Processing Unit) including an interface with a peripheral device, a control device, a processing device, a register, and the like. For example, the above-described baseband signal processing unit 104, call control unit 105, and the like may be implemented by the processor 1001.

Additionally, the processor 1001 reads a program (program code), a software module, data, and so forth, from at least one of the storage 1003 and the communication device 1004 to the memory 1002, and executes various processes according to these. As the program, a program is used which causes a computer to execute at least a part of the operations described in the above-described embodiments. For example, the control unit 401 of the communication apparatus 20 may be implemented by a control program that is stored in the memory 1002 and that is operated by the processor 1001, and another functional block may be implemented similarly. The above-described various processes are described to be implemented by a single processor 1001. However, the above-described various processes may be executed simultaneously or sequentially by two or more processors 1001. The processor 1001 may be implemented by one or more chips. The program may be transmitted from a network via a telecommunications line.

The memory 1002 is a computer readable storage medium, and, for example, the memory 1002 may be formed of at least one of a Read Only Memory (ROM), an Erasable Programmable ROM (EPROM), an Electrically Erasable Programmable ROM (EEPROM), a Random Access Memory (RAM), and so forth. The memory 1002 may be referred to as a register, a cache, a main memory (main storage device), or the like. The memory 1002 may store a program (program code), a software module, or the like, which can be executed for implementing the radio communication method according to the embodiments of the present disclosure.

The storage 1003 is a computer readable storage medium and may be formed of, for example, at least one of an optical disk, such as a CD-ROM

(Compact Disc ROM), a hard disk drive, a flexible disk, an optical magnetic disk (e.g., a compact disk, a digital versatile disk, a Blu-ray (registered trademark) disk), a smart card, a flash memory (e.g., a card, a stick, a key drive), a floppy (registered trademark) disk, a magnetic strip, etc. The storage 1003 may be referred to as an auxiliary storage device. The above-described storage medium may be, for example, a database including at least one of the memory 1002 and the storage 1003, a server, or any other suitable medium.

The communication device 1004 is hardware (transmitting and receiving device) for performing communication between computers through at least one of a wired network and a wireless network, and is also referred to, for example, as a network device, a network controller, a network card, a communication module, and so forth. The communication device 1004 may be configured to include, for example, a high frequency switch, a duplexer, a filter, a frequency synthesizer, and so forth, to implement at least one of frequency division duplex (FDD: Frequency Division Duplex) and time division duplex (TDD: Time Division Duplex). For example, the above-described transmitting and receiving antenna 101, an amplifier 102, the transmitting and receiving unit 103, a transmission line interface 106 and the like may be implemented by the communication device 1004. The transmitting and receiving unit 103 may be implemented so that a transmitting unit 103a and a receiving unit 103b are physically or logically separated.

The input device 1005 is an input device (e.g., a keyboard, mouse, microphone, switch, button, sensor, or the like) that receives an external input. The output device 1006 is an output device (e.g., a display, speaker, LED lamp, or the like) that implements an external output. The input device 1005 and the output device 1006 may have an integrated configuration (for example, a touch panel).

Each device, such as the processor 1001 and the memory 1002, is also connected by the bus 1007 for communicating information. The bus 1007 may be formed of a single bus or may be formed of different buses between devices.

The communication apparatus 20 and the base station 10 may each include hardware, such as a microprocessor, a digital signal processor (DSP: Digital Signal Processor), an Application Specific Integrated Circuit (ASIC), a Programmable Logic Device (PLD), and a Field Programmable Gate Array (FPGA), which may implement some or all of each functional block. For example, processor 1001 may be implemented using at least one of these hardware components.

### Conclusion of the Embodiments

In this specification, at least the following communication apparatus and channel state information measuring method are disclosed.

A communication apparatus including a receiving unit that receives a first synchronization signal from a synchronization source; a control unit that identifies, prior to receiving the first synchronization signal by the receiving unit, a value corresponding to a number of times of relaying the first synchronization signal, and that identifies a resource assignment corresponding to the identified value; and a transmitting unit that transmits a second synchronization signal by using a transmission resource assigned by the identified resource assignment.

According to this configuration, in a case where a transmitting communication apparatus receives a sidelink synchronization signal transmitted from another communication apparatus, and relays, to a receiving communication apparatus, a sidelink synchronization signal using the another communication apparatus as a synchronization source, the transmitting communication apparatus can transmit, to the receiving communication apparatus, a notification of a value corresponding to the number of times of relaying the synchronization signal. Accordingly, the receiving communication apparatus can select as to whether the received synchronization signal is used for synchronization processing based on the value corresponding to the number of times of relaying the synchronization signal.

The control unit may identify the value corresponding to the number of times of relaying the first synchronization signal based on information included in a physical sidelink broadcast channel (PSBCH), a sequence applied to the first synchronization signal, or a resource location at which the first synchronization signal is received, or a combination thereof. According to this configuration, the value corresponding to the number of times of relaying the first synchronization signal may be efficiently transmitted to the receiving communication apparatus.

The control unit may search for the first synchronization signal from resources in a descending order of priority based on a correspondence between a resource location and a priority level, and may identify the value corresponding to the number of times of relaying the first synchronization signal based on a number of times the search is performed until the first synchronization signal is detected. According to this configuration, an overhead for transmitting the value corresponding to the number of times of relaying the first synchronization signal to the receiving communication apparatus can be reduced.

The control unit may select whether the first synchronization signal is to be used for synchronization for sidelink communication, based on the identified value corresponding to the number of times of relaying the first synchronization signal. According to this configuration, it is possible to prevent a decrease in synchronization accuracy caused by relaying the synchronization signal multiple times.

A communication method executed by a communication apparatus, the method including a step of receiving a first synchronization signal from a synchronization source; a step of identifying, prior to receiving the first synchronization signal by the step of receiving, a value corresponding to a number of times of relaying the first synchronization signal, and identifying a resource assignment corresponding to the identified value; and a step of transmitting a second synchronization signal by using a transmission resource assigned by the identified resource assignment.

According to this configuration, in a case where a transmitting communication apparatus receives a sidelink synchronization signal transmitted from another communication apparatus, and relays, to a receiving communication apparatus, a sidelink synchronization signal using the another communication apparatus as a synchronization source, the transmitting communication apparatus can transmit, to the receiving communication apparatus, a notification of a value corresponding to the number of times of relaying the synchronization signal. Accordingly, the receiving communication apparatus can select as to whether the received synchronization signal is used for synchronization processing based on the value corresponding to the number of times of relaying the synchronization signal.

### Supplemental Embodiments

While the embodiments of the present invention are described above, the disclosed invention is not limited to the embodiments, and those skilled in the art will appreciate various alterations, modifications, alternatives, substitutions, etc. Descriptions are provided using specific numerical examples to facilitate understanding of the invention, but, unless as otherwise specified, these values are merely examples and any suitable value may be used. Classification of the items in the above descriptions is not essential to the present invention, and the items described in two or more items may be used in combination as needed, or the items described in one item may be applied (provided that there is no contradiction) to the items described in another item. The boundaries of functional units or processing units in the functional block diagram do not necessarily correspond to the boundaries of physical components. An operation by a plurality of functional units may be physically performed by one component or an operation by one functional unit may be physically executed by a plurality of components. For the processing procedures described in the embodiments, the order of processing may be changed as long as there is no contradiction. For the convenience of the description of the process, the communication apparatus 20 and the base station 10 are described using functional block diagrams, but such devices may be implemented in hardware, software, or a combination thereof. Software operated by a processor included in the communication apparatus 20 in accordance with embodiments of the present invention and software operated by a processor included in the base station 10 in accordance with embodiments of the present invention may be stored in a random access memory (RAM), a flash memory (RAM), a read-only memory (ROM), an EPROM, an EEPROM, a register, a hard disk (HDD), a removable disk, a CD-ROM, a database, a server, or any other suitable storage medium, respectively.

Notification of information is not limited to the aspects/embodiments described in the disclosure, and notification of information may be made by another method. For example, notification of information may be implemented by physical layer signaling (e.g., Downlink Control Information (DCI), Uplink Control Information (UCI), higher layer signaling (e.g., Radio Resource Control (RRC) signaling, Medium Access Control (MAC) signaling, broadcast information (Master Information Block (MIB), System Information Block (SIB))), or other signals or combinations thereof. RRC signaling may be referred to as an RRC message, for example, which may be an RRC connection setup message, an RRC connection reconfiguration message, etc.

The aspects/embodiments described in this disclosure may be applied to a system using at least one of Long Term Evolution (LTE), LTE-Advanced LTE-A), SUPER 3G, IMT-Advanced, 4th generation mobile communication system (4G), 5th generation mobile communication system (5G), Future Radio Access (FRA), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), any other appropriate system, and a next generation system extended based on theses. Additionally, a plurality of systems may be combined (e.g., a combination of at least one of LTE and LTE-A and 5G) to be applied.

The processing procedures, sequences, flow charts, or the like of each aspect/embodiment described in this disclosure may be reordered, provided that there is no contradiction. For example, the methods described in this disclosure present elements of various steps in an exemplary order and are not limited to the particular order presented.

The particular operation described in this disclosure to be performed by the base station 10 may be performed by an upper node in some cases. It is apparent that in a network consisting of one or more network nodes having the base station 10, various operations performed for communicating with the communication apparatus may be performed by at least one of the base station 10 and a network node other than the base station 10 (e.g., MME or S-GW can be considered, however, the network node is not limited to these). The case is exemplified above in which there is one network node other than the base station 10. However, the network node other than the base station 10 may be a combination of multiple other network nodes (e.g., MME and S-GW).

Input and output information and so forth may be stored in a specific location (e.g., memory) or managed using management tables. Input and output information and so forth may be overwritten, updated, or added. Output information or the like may be deleted. The input information or the like may be transmitted to another device.

The determination may be made by a value (0 or 1) represented by 1 bit, by a true or false value (Boolean: true or false), or by comparison of numerical values (e.g., a comparison with a predefined value).

The aspects/embodiments described in this disclosure may be used alone, in combination, or switched with implementation. Notification of predetermined information (e.g. “X” notice) is not limited to a method that is explicitly performed, and may also be made implicitly (e.g. “no notice of the predetermined information”). While the present disclosure is described in detail above, those skilled in the art will appreciate that the present disclosure is not limited to the embodiments described in this specification. The present disclosure may be implemented as modifications and variations without departing from the gist and scope of the present disclosure as defined by the claims. Accordingly, the description of the present disclosure is for purposes of illustration and is not intended to have any limiting meaning with respect to the present disclosure.

Software should be broadly interpreted to mean, regardless of whether referred to as software, firmware, middleware, microcode, hardware description language, or any other name, instructions, sets of instructions, code, code segments, program code, programs, subprograms, software modules, applications, software applications, software packages, routines, subroutines, objects, executable files, executable threads, procedures, functions, and the like.

Software, instructions, information, and the like may also be transmitted and received via a transmission medium. For example, when software is transmitted from a website, server, or other remote source using at least one of wireline technology (such as coaxial cable, fiber optic cable, twisted pair, digital subscriber line (DSL: Digital Subscriber Line)) and wireless technology (infrared, microwave, etc.), at least one of these wireline technology and wireless technology is included within the definition of a transmission medium.

The information, signals, and so forth described in this disclosure may be represented using any of a variety of different techniques. For example, data, instructions, commands, information, signals, bits, symbols, chips, etc., which may be referred to throughout the above description may be represented by voltages, currents, electromagnetic waves, magnetic fields or magnetic particles, optical fields or photons, or any combination thereof.

The terms described in this disclosure and those necessary for understanding this disclosure may be replaced with terms having the same or similar meanings. For example, at least one of the channels and the symbols may be a signal (signaling). The signal may also be a message. Furthermore, a component carrier (CC: Component Carrier) may be referred to as a carrier frequency, a cell, a frequency carrier, or the like.

As used in this disclosure, the terms “system” and “network” are used interchangeably. The information, parameters, and the like described in the present disclosure may also be expressed using absolute values, relative values from predetermined values, or they may be expressed using corresponding separate information. For example, radio resources may be those indicated by an index.

The name used for the parameters described above are not restrictive in any respect. In addition, the mathematical equations using these parameters may differ from those explicitly disclosed in this disclosure. Since the various channels (e.g., PUCCH, PDCCH, or the like) and information elements can be identified by any suitable name, the various names assigned to these various channels and information elements are not in any way limiting.

In this disclosure, the terms “Base Station (BS: Base Station),” “Radio Base Station,” “Fixed Station,” “NodeB,” “eNodeB (eNB),” “gNodeB (gNB),” “Access Point,” “Transmission Point,” “Reception Point,” “Transmission/Reception Point,” “Cell,” “Sector,” “Cell Group,” “Carrier,” “Component Carrier,” and the like, may be used interchangeably. The base station may be called by a term, such as macro-cell, small-cell, femto-cell, or pico-cell.

The base station can accommodate one or more (e.g., three) cells. Where the base station accommodates a plurality of cells, the entire coverage area of the base station can be divided into a plurality of smaller areas, each smaller area can also provide communication services by means of a base station subsystem (e.g., an indoor small base station (RRH) or a remote Radio Head). The term “cell” or “sector” refers to a portion or all of the coverage area of at least one of the base station and base station subsystem that provides communication services at the coverage.

In this disclosure, terms such as “mobile station (MS: Mobile Station)”, “user terminal”, “user equipment (UE: User Equipment)”, “terminal”, or the like may be used interchangeably.

A mobile station may be referred to by one of ordinary skill in the art as a subscriber station, a mobile unit, a subscriber unit, a wireless unit, a remote unit, a mobile device, a wireless device, a wireless communication apparatus, a remote device, a mobile subscriber station, an access communication apparatus, a mobile communication apparatus, a wireless communication apparatus, a remote communication apparatus, a handset, a user agent, a mobile client, a client, or some other suitable term.

At least one of a base station and a mobile station may be referred to as a transmitter, receiver, a communication apparatus, etc. At least one of a base station and a mobile station may be a device installed in a mobile body, a mobile body itself, etc. The mobile body may be a vehicle (e.g., a car, an airplane, etc.), an unmanned mobile (e.g., a drone, an automated vehicle, etc.), or a robot (manned or unmanned). At least one of a base station and a mobile station includes a device that does not necessarily move during communication operations. For example, at least one of a base station and a mobile station may be an Internet of Things (IoT) device such as a sensor.

In addition, the base station in the present disclosure may be read by the user terminal. For example, various aspects/embodiments of the present disclosure may be applied to a configuration in which communication between the base stations and the user terminal is replaced with communication between multiple user terminals (e.g., may be referred to as Device-to-Device (D2D), Vehicle-to-Everything (V2X), etc.). In this case, a configuration may be such that the above-described function of the base station 10 is included in the user terminal 20. The terms “up” and “down” may also be replaced with the terms corresponding to communication apparatus-to-communication apparatus communication (e.g., “side”). For example, an uplink channel, a downlink channel, etc., may be replaced with a sidelink channel. Similarly, a communication apparatus according to the present disclosure may be replaced with a base station. In this case, a configuration may be such that, the function included in the above-described communication apparatus 20 is included in the base station 10.

The term “connected” or “coupled” or any variation thereof means any direct or indirect connection or connection between two or more elements and may include the presence of one or more intermediate elements between two elements “connected” or “coupled” with each other. The coupling or connection between the elements may be physical, logical, or a combination of these. For example, “connection” may be replaced with “access.” As used in the present disclosure, the two elements may be considered as being “connected” or “coupled” to each other using at least one of the one or more wires, cables, and printed electrical connections and, as a number of non-limiting and non-inclusive examples, electromagnetic energy having wavelengths in the radio frequency region, the microwave region, and the light (both visible and invisible) region.

The reference signal may be abbreviated as RS (Reference Signal) or may be referred to as a pilot, depending on the standards applied.

As used in this disclosure, the expression “based on” does not mean “based on only” unless otherwise specified. In other words, the expression “based on” means both “based on only” and “at least based on.”

As long as “include,” “including,” and variations thereof are used in this disclosure, the terms are intended to be inclusive in a manner similar to the term “comprising.” Furthermore, the term “or” used in the disclosure is intended not to be an exclusive OR.

In the present disclosure, for example, if an article is added by translation, such as a, an, and the in English, the present disclosure may include that the noun following the article is plural.

In the present disclosure, the term “A and B are different” may imply that “A and B are different from each other.” Note that the term may also imply “each of A and B is different from C.” The terms, such as “separated,” “coupled,” etc., may also be interpreted similarly.

While the present invention is described in detail above, those skilled in the art will appreciate that the present invention is not limited to the embodiments described in this specification. The present invention may be implemented as modifications and variations without departing from the gist and scope of the present invention as defined by the claims. Accordingly, the description of the specification is for illustrative purposes only and is not intended to have any restrictive meaning with respect to the present invention.

### LIST OF REFERENCE SYMBOLS

101 transmitting unit

102 receiving unit

103 configuration information managing unit

104 control unit

201 transmitting unit

202 receiving unit

203 configuration information managing unit

204 control unit

1001 processor

1002 memory

1003 storage

1004 communication device

1005 input device

1006 output device

1. A communication apparatus comprising:
a receiving unit that receives a first synchronization signal from a synchronization source;
a control unit that identifies, prior to receiving the first synchronization signal by the receiving unit, a value corresponding to a number of times of relaying the first synchronization signal, and that identifies a resource assignment corresponding to the identified value; and
a transmitting unit that transmits a second synchronization signal by using a transmission resource assigned by the identified resource assignment.

2. The communication apparatus of claim 1, wherein the control unit identifies the value corresponding to the number of times of relaying the first synchronization signal based on information included in a physical sidelink broadcast channel (PSBCH), a sequence applied to the first synchronization signal, or a resource location at which the first synchronization signal is received, or a combination thereof.

3. The communication apparatus of claim 1, wherein the control unit searches for the first synchronization signal from resources in a descending order of priority based on a correspondence between a resource location and a priority level, and identifies the value corresponding to the number of times of relaying the first synchronization signal based on a number of times the search is performed until the first synchronization signal is detected.

4. The communication apparatus of claim 1, wherein the control unit selects whether the first synchronization signal is to be used for synchronization for sidelink communication, based on the identified value corresponding to the number of times of relaying the first synchronization signal.

5. A communication method executed by a communication apparatus, the method comprising:
a step of receiving a first synchronization signal from a synchronization source;
a step of identifying, prior to receiving the first synchronization signal by the step of receiving, a value corresponding to a number of times of relaying the first synchronization signal, and identifying a resource assignment corresponding to the identified value; and
a step of transmitting a second synchronization signal by using a transmission resource assigned by the identified resource assignment.
